(19) United States
(12) Patent Application Publication
(10) Pub. No.: US 2026/0095737 A1
(43) Pub. Date: Apr. 2, 2026

(54) System and Method for Text-Based Emergency Communication

(71) Applicant: Lisa Robinson, Fredericksburg, VA (US)

(72) Inventor: Lisa Robinson, Fredericksburg, VA (US)

(21) Appl. No.: 19/297,110

(22) Filed: Aug. 12, 2025

Related U.S. Application Data
(60) Provisional application No. 63/700,182, filed on Sep. 27, 2024.

(51) Int. Cl. H04W 4/90; H04W 4/14

(52) U.S. Cl. CPC H04W 4/90; H04W 4/14

(57) ABSTRACT

The present invention is a 9-1-1 emergency response system that integrates text-based communication. The system transitions from voice to text communication when a caller inputs a predefined code during a voice call. A text messaging module halts audio transmission and activates a text interface, enabling callers to send detailed messages or predefined emergency codes. The system determines the caller's location through cellular or network-based methods and forwards the emergency details to an appropriate call taker and emergency dispatcher based on the type and location of the emergency. A software application provides a user-friendly interface compatible with standard mobile operating systems and feature phones for providing text-based emergency requests. The system supports predefined emergency codes for quick response and sends confirmation messages to the caller.

### CROSS-REFERENCE TO RELATED APPLICATION

The present application claims priority to, and the benefit of, U.S. Provisional Application No. 63/700,182 which was filed on Sep. 27, 2024, and is incorporated herein by reference in its entirety.

### FIELD OF THE INVENTION

The present invention generally relates to emergency communication systems. More specifically, the invention relates to a 9-1-1 emergency response system designed to integrate text-based communication options for individuals in situations where verbal communication is unsafe or impossible. The system is compatible with mobile operating systems and feature phones. The system includes a text messaging module for receiving detailed emergency messages or predefined emergency codes, enabling quick and efficient communication with emergency responders. A host computer facilitates location determination and connects callers to the appropriate call takers and emergency dispatchers in real-time. Accordingly, the present disclosure makes specific reference thereto. Nonetheless, it is to be appreciated that aspects of the present invention are also equally applicable to other like applications, devices, and methods of manufacture.

### BACKGROUND

By way of background, 9-1-1 is the designated emergency services number in the United States and is widely used by citizens to access police, fire, or medical assistance during critical situations. Typically, individuals in distress contact 9-1-1 by initiating a voice call and verbally communicating the nature of their emergency. However, there are scenarios where speaking may not be feasible, such as when a caller is in physical danger, incapacitated, or unable to communicate due to injury or disability. In such situations, emergency service operators face significant challenges in determining the type of assistance required, which can delay response times. The inability to provide timely and accurate support during emergencies may lead to severe consequences, including the escalation of life-threatening conditions, significant injuries, or even fatalities. Individuals desire a system that enables callers to discreetly and efficiently communicate their emergencies when verbal communication is not possible.

Therefore, there exists a long-felt need in the art for a 9-1-1 emergency response system that enables individuals in distress to communicate effectively when verbal communication is unsafe or impossible. There is a long-felt need for a system that provides an alternative communication channel for situations where speaking could endanger the caller, such as during criminal activity or medical emergencies. Additionally, there is a long-felt need for an emergency system that ensures accessibility for individuals with speech or hearing impairments. Furthermore, there is a long-felt need for a system that facilitates quick and accurate communication of emergency details while maintaining discretion. More specifically, there exists a long-felt need in the art for a 9-1-1 emergency response system that transitions seamlessly from voice to text-based communication, enabling real-time interaction between the caller and emergency personnel. Finally, there is a long-felt need for a system that integrates with existing 9-1-1 infrastructure and ensures user-friendly functionality for widespread adoption.

The subject matter disclosed and claimed herein, in one embodiment, comprises a 9-1-1 emergency response system that integrates a text-based communication option into the existing 9-1-1 infrastructure. The system includes a software application compatible with standard mobile operating systems and feature phones, enabling callers to discreetly send text messages during emergencies. The system enables callers to input a predefined code during a voice call to transition to text mode, at which point the audio transmission is halted, and a text-based interface is activated. The text messaging module enables users to send predefined emergency codes or detailed messages, while a host computer determines the caller's location and forwards emergency details to the appropriate dispatcher. Call takers can communicate with callers in real-time and relay critical information to emergency responders based on the nature of the emergency.

In this manner, the 9-1-1 emergency response system of the present invention accomplishes all of the foregoing objectives and provides a solution for enhancing emergency communication. The transition from voice to text enables the individuals in dangerous or compromised situations to request assistance without compromising their safety. The use of predefined emergency codes enables quick response times. The system integrates text-based communication into the existing 9-1-1 infrastructure to enable users to communicate effectively and discreetly during emergencies, significantly improving safety and emergency response outcomes.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a 9-1-1 emergency text-based response system. The system comprises a caller device configured to access a software application for contacting 9-1-1 emergency services, a handling system is operatively coupled to the caller device and is configured to recognize a switch code entered by the caller during a voice call to 9-1-1, transfer the call to a text messaging module upon recognition of the code, wherein the text messaging module halts audio transmission and provides a text interface for the caller, a host computer is operatively coupled to the text messaging module and configured to determine a location of the caller based on cellular or network data, select at least one call taker from a plurality of call takers based on the caller's location, establish communication between the call taker and the caller through the text interface, facilitate communication between the call taker and one or more emergency dispatchers based on the type of emergency, wherein the system enables text-based emergency communication for discreet and accessible interaction.

In another aspect, a 9-1-1 emergency text-based response system is disclosed. The system includes a text messaging module integrated with a software application accessible on standard mobile operating systems and feature phones, the text messaging module is configured to transmit predefined emergency prompts to a caller upon activation by a specific code entered during a voice call to 9-1-1, receive emergency details or predefined emergency codes from the caller through a text interface, a host computer is configured to identify the type of emergency based on the received details or codes, and transmit the identified emergency to at least one emergency dispatcher along with the caller's location.

In another embodiment, a software application for integrating text-based communication into a 9-1-1 emergency response system is disclosed. The application includes an interface configured to enable a caller to input a specific code during a voice call to transition to text-based communication, a text messaging module operable to send emergency requests or codes and receive emergency response via the interface, wherein the application enables discreet and accessible emergency communication for users unable to speak during emergencies.

In one embodiment, a method for transitioning a 9-1-1 voice call to text-based communication is disclosed. The method includes receiving, via a cellular or Wi-Fi network, a voice call initiated by a caller to 9-1-1 emergency services, detecting a specific code input by the caller during the voice call, halting audio transmission upon recognition of the specific code and activating a text interface for the caller, receiving an emergency request or predefined emergency code via the text interface, determining the caller's location and type of emergency based on the received request or code, and transmitting the emergency request to at least one emergency dispatcher for response, wherein a confirmation message is sent back to the caller via the text interface.

In another aspect, a method for transitioning from a voice-based (i.e., audio-based) emergency call to text-based communication in a 9-1-1 emergency response system is disclosed. The method includes receiving a voice call initiated by a caller to 9-1-1 emergency services, detecting a specific input code provided by the caller during the voice call, halting audio transmission upon recognition of the specific code, and initiating a text-based communication interface for the caller to send emergency details.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of 9-1-1 emergency text-based response system of the present invention in accordance with the disclosed architecture;

FIG. 2 illustrates an exemplary interface displayed by the software application for facilitating text-based communication by a caller in accordance with one embodiment of the present invention;

FIG. 3 illustrates a plurality of exemplary emergency codes used in the text-based 9-1-1 emergency response system in accordance with one embodiment of the present invention;

FIG. 4 illustrates a flow chart depicting a process of providing emergency help to a caller of the text-based 9-1-1 system of the present invention in accordance with the disclosed architecture; and

FIG. 5 illustrates a process of providing emergency response to the caller based on an emergency code in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a 9-1-1 emergency response system that enables individuals in distress to communicate effectively when verbal communication is unsafe or impossible. There is a long-felt need for a system that provides an alternative communication channel for situations where speaking could endanger the caller, such as during criminal activity or medical emergencies. Additionally, there is a long-felt need for an emergency system that ensures accessibility for individuals with speech or hearing impairments. Furthermore, there is a long-felt need for a system that facilitates quick and accurate communication of emergency details while maintaining discretion. More specifically, there exists a long-felt need in the art for a 9-1-1 emergency response system that transitions seamlessly from voice to text-based communication, enabling real-time interaction between the caller and emergency personnel. Finally, there is a long-felt need for a system that integrates with existing 9-1-1 infrastructure and ensures user-friendly functionality for widespread adoption.

The present invention, in one exemplary embodiment, is a 9-1-1 emergency text-based response system. The system comprises a caller device configured to access a software application for contacting 9-1-1 emergency services, a handling system is operatively coupled to the caller device and is configured to recognize a switch code entered by the caller during a voice call to 9-1-1, transfer the call to a text messaging module upon recognition of the code, wherein the text messaging module halts audio transmission and provides a text interface for the caller, a host computer is operatively coupled to the text messaging module and configured to determine a location of the caller based on cellular or network data, select at least one call taker from a plurality of call takers based on the caller's location, facilitate communication between the call taker and one or more emergency dispatchers based on the type of emergency, wherein the system enables text-based emergency communication for discreet and accessible interaction.

Reference will now be made in detail to the present preferred embodiments of the invention, examples of which are illustrated in the accompanying drawings. Wherever possible, the same reference numerals are used in the drawings and the description to refer to the same or like parts.

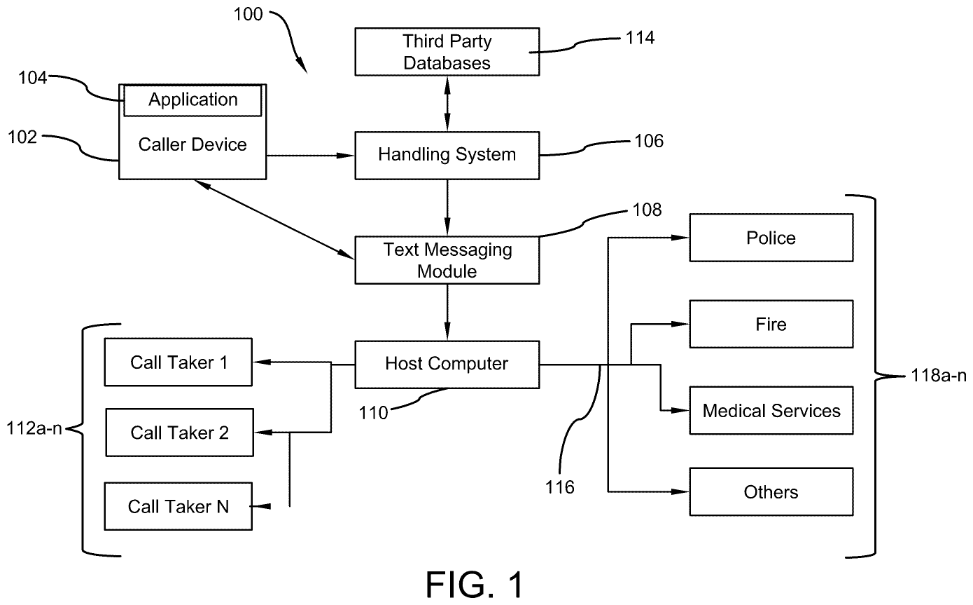

Referring initially to the drawings, FIG. 1 illustrates a diagrammatic view of 9-1-1 emergency text-based response system of the present invention in accordance with the disclosed architecture. The 9-1-1 emergency text-based response system 100 of the present invention is designed as an enhanced functionality or platform accessible to callers to enhance the functionality of the existing 9-1-1 emergency call system by integrating a text-based communication option. The system 100 may be accessible in the form of an application which is built to integrate with the current 9-1-1 emergency response system. The system 100 is configured to be compatible with standard mobile operating systems (IOS, Android, and more) and feature phones is ensured for widespread accessibility.

More specifically, a caller using a caller device 102 accesses interface of the software application 104 for contacting 9-1-1 emergency service. The caller dials the 9-1-1 service and presses a specific code #9 or 1234 or any other code to switch to a text interface for sending text messages to the emergency service. In some embodiments, the conventional keypad for calling 9-1-1 emergency service can be used for dialing and inputting the specific code and the software application 104 is automatically activated when the specific code is successfully typed-in by the user.

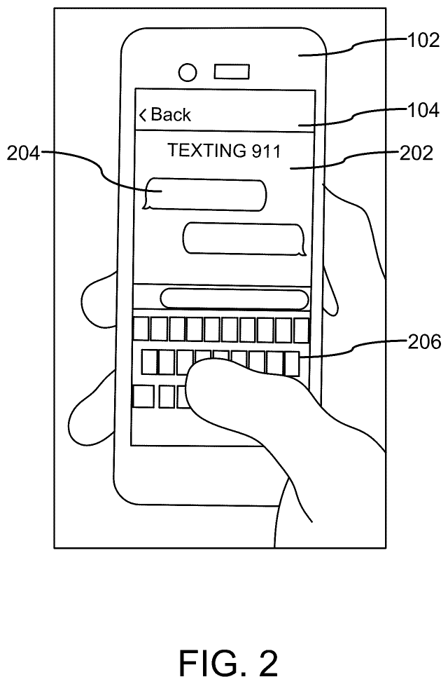

The system 100 includes a handling system 106 which is configured to recognize the code entered by the user. The handling system 106 on recognition of the code, transfers the audio call to a text messaging module 108 and stops transmitting audio to maintain discretion. The text messaging module 108 automatically sends a predefined (i.e., predetermined) message as illustrated in FIG. 2. It should be noted that in some embodiments, the predefined message is automatically displayed in the application 104 and may not be transmitted by the text messaging module 108.

A host computer 110 coupled to the text messaging module 108 selects at least one call taker based on location of the caller. A plurality of call takers 112a-n may be used for communication with the caller and can communicate in real-time with the caller. In the present embodiment, preferably, third party databases 114 such as local databases, cellular number databases, and more are used for automatically identifying the location of the caller and the call taker from the plurality of call takers 112a-n is chosen based on location of the caller. In some embodiments, the system 100 may use hybrid location tracking (GPS, cellular triangulation, and Wi-Fi positioning) for precise caller location, even in poor network conditions.

The host computer 110 provides a communication channel 116 of the call takers with a plurality of emergency dispatchers 118a-n depending on the type of emergency in which the caller is in. A confirmation message is also delivered by the call taker using the text messaging module when one or more emergency dispatchers are contacted by the call taker. The system 100 secures all text communications with end-to-end encryption to ensure data confidentiality.

FIG. 2 illustrates an exemplary interface displayed by the software application for facilitating text-based communication by a caller in accordance with one embodiment of the present invention. The application 104 can be automatically opened or activated when the switch code for transition from voice to text is pressed by the caller or the application 104 may be directly used by the caller to dial 9-1-1. The interface 202 of the application 104 provides an automatic and predefined message 204, preferably asking the type of emergency.

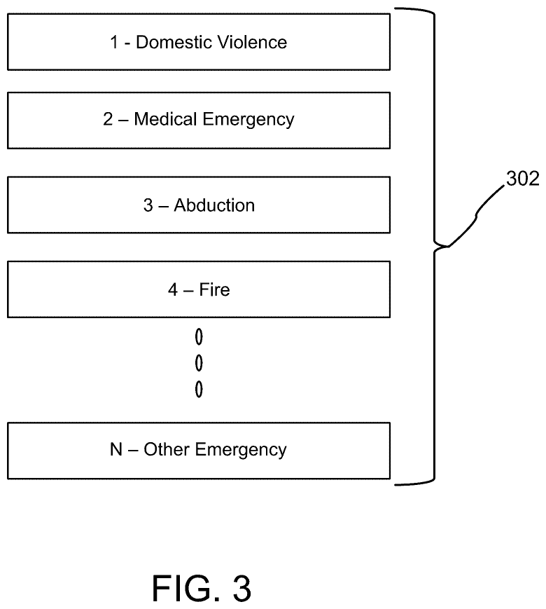

Then, the caller using the keypad 206 of the device 102 can type the message indicating the emergency and help required such as “Someone is in the house. Please send help to evacuate”. In some embodiments, for quick response by the caller, the application 104 provides a plurality of predefined codes corresponding to different emergency situations as described in FIG. 3. One or more emergency codes can be directly input by the caller for a quick response.

FIG. 3 illustrates a plurality of exemplary emergency codes used in the text-based 9-1-1 emergency response system in accordance with one embodiment of the present invention. The system 100 supports a plurality of predefined emergency codes 302 which can be used by the caller to indicate the type of emergency. As illustrated, “1” can be typed in the keypad 206 for indicating a domestic violence, “2” can be used for indicating Medical Emergency, “3” can be used for abduction, “4” can be used for Fire, and similar a plurality of other codes can be predefined for the callers for easily indicating the emergency. In some embodiments, the predefined message in the application 104 as described in FIG. 2, may be “This is 9-1-1. You are now in text mode. Please describe your emergency or use predefined codes” and the list of the emergency codes can be displayed for the caller to select.

It should be noted that the system 100 and the application 104 enable individuals in dangerous situations to seek help discreetly and serve individuals with disabilities and those who cannot speak during an emergency.

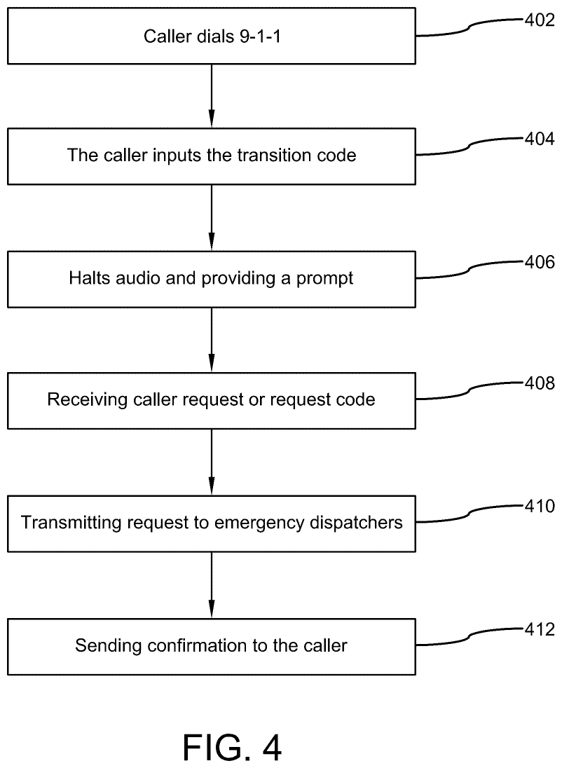

FIG. 4 illustrates a flow chart depicting a process of providing emergency help to a caller of the text-based 9-1-1 system of the present invention in accordance with the disclosed architecture. Initially, a caller dials 9-1-1 using the cellular network or can be called using a Wi-Fi network (Step 402). Then, the caller inputs the switch code or the transition code to switch the communication channel from the voice-based (i.e., audio-based) to text-based (Step 404). On receiving the switch code, the system halts the audio channel, and a text-based interface is opened in the application 104 with an automatic prompt for the caller (Step 406). Thereafter, the system 100 receives the emergency request from the caller in the form of a text message or alternatively, the request can be received in the form of an emergency request code (Step 408). Based on at least location of the caller and type of the emergency request, the emergency request is transmitted to at least one emergency dispatcher for providing emergency response to the caller (Step 410). Finally, the emergency response and emergency response dispatcher confirmation are sent to the caller via a text message (Step 412).

In some embodiments of the present invention, the application 104 may send repeated message for a predetermined time period when an emergency request or code is not received from the caller. After the predetermined time period, the system 100 may call the caller to reconnect.

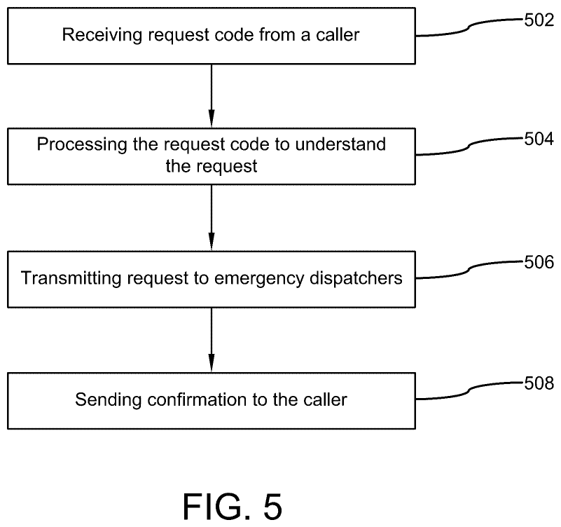

FIG. 5 illustrates a process of providing emergency response to the caller based on an emergency code in accordance with one embodiment of the present invention. As illustrated, the system 100 receives an emergency request code from the caller submitted using the application 104 (Step 502). Then, the request code is processed to understand and identify the emergency in which the caller is in (Step 504). Based on the identified emergency, a request for help is transmitted to at least one emergency dispatcher (Step 506). Finally, a confirmation is sent to the caller in the form of a text message (Step 508).

The present invention protects the caller in dangerous situations by providing a silent communication. Further, the system 100 relies on well-known user interactions such as keypad codes, SMS, and instant messaging. The invention provides real-time transition from the conventional 9-1-1 calling and accommodates users with speech or hearing impairments.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “9-1-1 emergency text-based response system”, “text-based 9-1-1 system”, “9-1-1 emergency text system”, and “system” are interchangeable and refer to the text-based 9-1-1 emergency response system 100 of the present invention.

Notwithstanding the forgoing, the text-based 9-1-1 emergency response system 100 of the present invention can be of any suitable configuration as is known in the art without affecting the overall concept of the invention, provided that it accomplishes the above stated objectives. One of ordinary skill in the art will appreciate that the text-based 9-1-1 emergency response system 100 as shown in the FIGS. are for illustrative purposes only, and that many other configurations of the text-based 9-1-1 emergency response system 100 are well within the scope of the present disclosure. Although the dimensions of the text-based 9-1-1 emergency response system 100 are important design parameters for user convenience, the text-based 9-1-1 emergency response system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An emergency text-based response system comprising:
a caller device;
a caller;
a text communication application;
a text interface;
a code;
an emergency caller line; and
a call;
wherein said emergency caller line is a 9-1-1 emergency service; and
further wherein actuation of said code switches from said emergency caller line to said text interface for sending text messages to emergency services.

2. The emergency text-based response system of claim 1, wherein said emergency caller line is an emergency audio caller line.

3. The emergency text-based response system of claim 2, wherein said caller device having a keypad for entering a number to access said emergency caller line and for entering said code.

4. The emergency text-based response system of claim 3 further comprising a handling system, wherein after actuation of said code, said handling system transfers said call to a text messaging module.

5. The emergency text-based response system of claim 4, wherein said handling system stops transmission of audio through said call.

6. The emergency text-based response system of claim 5, wherein said text message is a predetermined text message.

7. The emergency text-based response system of claim 6 further comprising a host computer coupled to said text interface, wherein said host computer selects at least one call taker based on a location of said caller.

8. The emergency text-based response system of claim 7, wherein said at least one call taker is selected from a plurality of call takers.

9. The emergency text-based response system of claim 8, wherein said at least one call taker in communication with said caller in real-time.

10. An emergency text-based response system comprising:
a caller device;
a caller;
a text communication application;
a text interface;
a code;
an emergency caller line;
a call; and
a handling system;
wherein said emergency caller line is a 9-1-1 emergency service;
wherein actuation of said code switches from said emergency caller line to said text interface for sending text messages to emergency services; and
further wherein said handling system, after actuation of said code, transfers said call to a text messaging module.

11. The emergency text-based response system of claim 10, wherein said emergency caller line is an emergency audio caller line.

12. The emergency text-based response system of claim 11, wherein said caller device having a keypad for entering a number to access said emergency caller line and for entering said code.

13. The emergency text-based response system of claim 12, wherein said handling system stops transmission of audio through said call.

14. The emergency text-based response system of claim 13, wherein said text message is a predetermined text message.

15. The emergency text-based response system of claim 14 further comprising a host computer coupled to said text interface, wherein said host computer selects at least one call taker based on a location of said caller.

16. The emergency text-based response system of claim 15, wherein said at least one call taker is selected from a plurality of call takers.

17. The emergency text-based response system of claim 16, wherein said at least one call taker in communication with said caller in real-time.

18. A method of communication with an emergency response system, the method comprising the steps of:
providing a caller device, a caller, a text communication application, a text interface, a code, an emergency caller line, and a call, wherein said emergency caller line is a 9-1-1 emergency service;
dialing said emergency caller line; and
actuating said code to switch said emergency caller line to said text interface for sending text messages to the 9-1-1 emergency service.

19. The method of communication with an emergency response system of claim 18, wherein said emergency caller line is initially an emergency audio caller line.

20. The method of communication with an emergency response system of claim 19, wherein said caller device having a keypad for entering a number to access said emergency caller line and for entering said code, and further wherein after actuation of said code, said text communication application switches said call to a text messaging module.
